(19) United States
(12) Patent Application Publication
(10) Pub. No.: US 2023/0078836 A1
(43) Pub. Date: Mar. 16, 2023

(54) METHOD AND CONTROL DEVICE FOR CONTROLLING A VEHICLE

(71) Applicant: ZF Friedrichshafen AG, Friedrichshafen (DE)

(72) Inventor: Gabriela Jager, Friedrichshafen (DE)

(73) Assignee: ZF Friedrichshafen AG, Friedrichshafen (DE)

(21) Appl. No.: 17/815,324

(22) Filed: Jul. 27, 2022

(30) Foreign Application Priority Data
Sep. 10, 2021 (DE) 10 2021 210 006.6

(51) Int. Cl. G05D 1/02; B60Q 9/00

(52) U.S. Cl. CPC G05D 1/0257; G05D 1/0214; B60Q 9/00; A01B 69/008

(57) ABSTRACT

A method for controlling a vehicle (100) includes reading-in measurement data about a surface (6) of a substrate (2) lying ahead of the vehicle (100) in its travel direction (F), where the surface contains a ground-level obstacle (4) and recognizing the ground-level obstacle (4) from the measurement data. The method also includes determining a movement vector (V4) of the recognized ground-level obstacle (4) in a vehicle-associated coordinate system on the basis of the measurement data read in and determining a movement vector (V1) of the vehicle (100) in a coordinate system superordinate relative to the vehicle-associated coordinate system. The method further includes checking whether the ground-level obstacle (4) is a dynamic ground-level obstacle (4) in the superordinate coordinate system and emitting a control signal for controlling an operational safety system (30) of the vehicle (100) as a function of the result of the check. Also disclosed is a control unit (200) for carrying out a method of that type and a vehicle (100) with a control unit (200) of that type.

### RELATED APPLICATIONS

This application claims the benefit of and right of priority under 35 U.S.C. § 119 to German Patent Application no. 10 2021 210 006.6, filed on Sep. 10, 2021, the contents of which are incorporated herein by reference in its entirety.

### TECHNICAL FIELD

The present invention relates to a method and a control unit for controlling a vehicle. The present invention also relates to a vehicle with a control unit of that type.

### BACKGROUND

It is known to register the surroundings of a vehicle by means of a sensor system installed on the vehicle, in order to control the vehicle on the basis of data detected by the sensor system. For example, for the automated control of the vehicle it is known, on the basis of such data, to identify an area which is navigable by the vehicle, or a potential collision hazard in the surroundings of the vehicle.

### SUMMARY

One aspect of the present invention relates to a method for controlling a vehicle. The said vehicle can be a self-driving working machine such as a building machine or an agricultural machine. The method can be carried out for the automated control of the vehicle. The vehicle can be one that can be operated without a driver.

As one step, the method comprises the reading-in of measurement data about a surface of a substrate ahead of the vehicle in its travel direction. The substrate can be a surface that the vehicle can drive over. For example, the substrate can be a roadway, a usable agricultural area, or a building site.

The substrate has a ground-level obstacle. The ground-level obstacle can be on the ground or substrate, such that the ground-level obstacle can move over the ground or substrate. For example, the ground-level obstacle can flow, slide or roll over the ground. The ground can be firm ground. Thus, the ground-level obstacle can be a moving or dynamic ground-level obstacle, such that the ground-level obstacle can move relative to adjacent, static areas of the substrate. The surface of the ground ahead of the vehicle in its travel direction can include the surface of the ground-level obstacle. The surface of the substrate ahead of the vehicle in its travel direction can also include the surface of the ground forming the substrate. Thus, the surfaces of the ground and of the ground-level obstacle can together form the surface of the substrate ahead of the vehicle in its travel direction.

The ground-level obstacle can be an obstacle over which the vehicle can drive. The ground-level obstacle can be a flat obstacle covering the ground, that can have dimensions extending along the ground which are larger than a dimension of the obstacle extending upward from the ground. The ground-level obstacle can be a foreign object. The foreign object can be a lost item of cargo or a lost load, which can be on the ground. For example, the ground-level obstacle can be building material or bulk material that has fallen off a transport vehicle and now forms a ground-level obstacle. For example, the ground-level obstacle can be building timber, tree trunk, gravel, or excavated earth. The foreign object can also be loose ground material or precipitated material, which can be present on the ground. Thus, for example, the ground-level obstacle can be material from a mudslide or avalanche. The foreign object can be on the ground temporarily.

The ground-level obstacle can also be a ground-level obstacle arranged on another vehicle or a machine. The ground-level obstacle can be transported or moved by the other vehicle. For example, the ground-level obstacle can be hauled over the ground on a building site by a crane or winch or kept on the ground. However, driving over the ground-level obstacle can affect the driving dynamics of the vehicle adversely, or even have the result that while driving over the ground-level obstacle the vehicle loses its traction. Driving over the ground-level obstacle can have the result that the vehicle can no longer transmit steering forces and braking forces to the ground forming the substrate. Thus, driving over the ground-level obstacle can seriously compromise the driving safety. The invention is based on the knowledge that the threats to driving safety described can occur in particularly severe form in the case of a moving ground-level obstacle.

The measurement data about the surface ahead of the vehicle in its travel direction are determined by means of an environment detection sensor system installed on the vehicle. As a further step, the method can therefore include the determination of the measurement data by the environment detection sensor system on the vehicle. In a further step of the method, the measured data can be filtered. According to an embodiment, the measured data are filtered along a ground-level strip, such that only measurement data in a ground-level zone are determined. The ground-level strip can extend parallel to a current longitudinal axis of the vehicle. In that way, measurement data can also be filtered when the vehicle is on an inclined substrate at the time. Thus, the measured data can relate to the substrate ahead regardless of whether the vehicle is currently inclined relative to the horizontal, and the substrate in a nearby area ahead can also be inclined. Furthermore, the measurement data determined can be filtered in a grid pattern. The measurement data can be filtered on the basis of a 3D-occupance grid.

In an embodiment, the environment detection sensor system or at least one of the environment detection sensors described can be arranged on the vehicle and a detection field of the environment detection sensor system or the environment detection sensor can be orientated in such manner that the detection field is directed obliquely downward or perpendicularly to the substrate. The environment detection sensor system or at least one of the environment detection sensors described can be arranged on the vehicle along a vehicle longitudinal axis or a distance away from the vehicle longitudinal axis. The environment detection sensor system or environment detection sensor can be arranged high up or exposed on the vehicle. The detection field can be orientated obliquely downward or perpendicularly in such manner that at least one measuring beam of the environment detection sensor system or environment detection sensor meets the substrate perpendicularly. Thus, the substrate can be observed in a nearby area ahead of the vehicle in its travel direction and by virtue of the method, ground-level obstacles in that area can also be recognized.

The environment detection sensor system can comprise at least one image-based environment detection sensor for observing the surface of the substrate lying ahead. The image-based environment detection sensor can be a camera. Accordingly, the measurement data can include at least one image of the surface of the substrate. The camera can be in the form of a mono-camera. The environment detection sensor system can also comprise a stereo-camera, from which, by means of stereo-photogrammetric methods, a point cloud of the surface of the substrate can be produced.

Alternatively, or in addition to the image-based environment detection sensor, the environment detection sensor system can comprise at least one distance-measuring environment detection sensor for the contactless scanning of the surface of the substrate lying ahead. The distance-measuring environment detection sensor can be an environment detection sensor that scans the surface of the substrate over an area or in a grid pattern. For example, the environment detection sensor is a laser scanner, a distance-measuring camera, a radar unit or an ultrasonic sensor.

If the environment detection sensor system comprises a distance-measuring environment detection sensor, the measurement data can comprise at least one point cloud of the surface of the substrate. The measurement data can include measured data obtained at intervals in time, such that the measured data are detected at different times. The measurement data can also include locally spaced data relating to a particular detection location, such that the measurement data can be obtained at various points along a movement trajectory of the vehicle.

As a further step the method includes the recognition of the ground-level obstacle in the measurement data read in. If the environment detection sensor system comprises the image-based environment detection sensor, the ground-level obstacle can be recognized in an image captured by the image-based environment detection sensor by virtue of image-processing methods. The image-processing methods can for example comprise a semantic segmentation, a classification method or an artificial intelligence (AI) method. Alternatively, or in addition to the image-based environment detection sensor, if the environment detection sensor system comprises the distance-measuring environment detection sensor. Then alternatively, or in addition to the image-processing methods, the ground-level obstacle can be recognized from the point cloud produced by the distance-measuring environment detection sensor using pattern-recognition methods. The pattern-recognition methods can, for example, comprise an automated matching process or a 3D reconstruction method. Accordingly, the recognition step can be carried out as automated recognition of the ground-level obstacle in the measurement data that has been read in.

As a further step the method includes a determination of a movement vector of the recognized ground-level obstacle in a vehicle-associated coordinate system based on the measurement data read in. The vehicle-associated coordinate system can be a coordinate system arranged on and connected to the vehicle. The vehicle-associated coordinate system can be a sensor coordinate system of the environment detection sensor system. The measurement data determined can have coordinates determined locally in the sensor coordinate system. The vehicle-associated coordinate system can be a vehicle coordinate system or an accompanying coordinate system. Steps of the method can be carried out repeatedly. For example, the movement vector can be determined repeatedly.

The movement vector of the ground-level obstacle determined in the vehicle-associated coordinate system can result from a movement of the ground-level obstacle. Alternatively, or in addition to the movement of the ground-level obstacle, the movement vector can result from a movement of the vehicle. If both the ground-level obstacle and the vehicle are moving, then the movement vector in the vehicle-associated coordinate system can be the result of both movements.

The measurement data read in can already contain movement information about the ground-level obstacle, from which the movement vector of the ground-level obstacle can be determined or derived. The movement information can be determined directly or indirectly by means of the environment detection sensor system installed on the vehicle. Alternatively, or in addition, the movement vector can be determined from measurement data separated in time. Thus, the movement vector can be determined from a spatially sequenced or tracking of the ground-level obstacle in the vehicle-associated coordinate system. The spatial sequence or tracking can be based on at least one of the methods of image processing and the methods of pattern recognition. If the measurement data include point clouds of the surface of the substrate, the ground-level obstacle can, for example, be followed or tracked by means of an ICP algorithm in the point cloud.

As a further step the method comprises a determination of a movement vector of the vehicle in a coordinate system that is superordinate relative to the vehicle-associated coordinate system. The superordinate coordinate system can be a coordinate system whose position is fixed relative to the ground forming the substrate. The ground-level obstacle can move in the superordinate coordinate system. The vehicle too can move in the superordinate coordinate system. By determining the movement vector in the superordinate coordinate system, it can be reliably checked whether the ground-level obstacle is a dynamic ground-level obstacle.

According to an embodiment of the method, as a further step the method can comprise a comparison of the movement vectors determined. The comparison can comprise a comparison of the sizes of the movement vectors determined. Alternatively, or in addition, the comparison can comprise a comparison of the directions of the movement vectors determined.

In a further step of the method, the number of movement vectors of the recognized ground-level obstacle can be determined. In an embodiment of the method, as a further step, the method can comprise a comparison of a number of the movement vectors of the recognized ground-level obstacle with a predetermined threshold value of the number of movement vectors of the recognized ground-level obstacle. The comparison can enable a detection of outliers in the measurement data. The comparison can also enable filtering out insignificant small objects which, when driven over, do not pose a safety risk for the vehicle.

As a further step the method comprises a check of whether the ground-level obstacle recognized is a dynamic ground-level obstacle in the superordinate coordinate system. The checking step can be carried out on the basis of the comparison of the movement vectors determined. If the sizes and directions of the movement vectors are in agreement, the ground-level obstacle recognized can be a stationary ground-level obstacle. The directions of the movement vectors determined are in agreement when the vectors determined are orientated oppositely to one another. If the movement vectors determined differ from one another in at least one of their sizes and their directions, the ground-level obstacle can be a dynamic ground-level obstacle. The checking step can be carried out on the basis of a check whether there is an epipolar condition between the movement vectors determined. Thus, the checking step can also be carried out on the basis of methods of epipolar geometry.

A check result of the checking process can be that the ground-level obstacle recognized is a dynamic ground-level obstacle in the superordinate coordinate system. A further check result of the checking process can be that the ground-level obstacle recognized is a ground-level obstacle which is stationary in the superordinate coordinate system.

As a further step the method comprises the output of a control signal for controlling an operational safety system of the vehicle as a function of a check result from the checking process. The control signal can be emitted when the result of the check shows that the ground-level obstacle recognized is a dynamic ground-level obstacle in the superordinate coordinate system. Alternatively, the control signal can be emitted when the ground-level obstacle recognized is a stationary ground-level obstacle in the superordinate coordinate system.

If steps of the method are carried out repeatedly, there may be a repeated check result. The step of emitting the control signal can only be carried out when the resulting check result matches a predetermined repetition number. In that way the method for controlling the operational safety system of the vehicle can be carried out more robustly and reliably.

According to a further embodiment, in a number of determined movement vectors of the ground-level obstacle recognized and nearby static substrate areas a scatter or variation of the orientations of the movement vectors determined can be observed. The step of determining the movement vector of the recognized ground-level obstacle and the checking step can also be carried out on the basis of the scatter or variation determined.

Thus, with the invention ground-level obstacles in the travel direction of a vehicle, which are ahead of it and moving, and moving substrate areas which can form corresponding substrate areas, can be recognized and on this basis and an operational safety system of the vehicle can be controlled. The operational safety system can be set up so that ahead of the moving substrate areas that form ground-level obstacles, a warning is issued, or the vehicle is prevented from driving over the moving substrate.

In an embodiment of the method, as a further step the method can comprise reading in information about dynamics of the vehicle in the superordinate coordinate system. The information can be based on measurement data determined by a sensor system installed on the vehicle. The sensor system can comprise an inertial measurement system or a navigation sensor for determining the dynamic of the vehicle. According to this embodiment, the step of determining the movement vector of the vehicle can be based on the information read in. Thus, the movement vector of the vehicle can define the current dynamic or movement of the vehicle in the superordinate coordinate system. The information about the dynamic of the vehicle can be read from an odometer fitted on the vehicle, such that the information can contain data about the longitudinal dynamics of the vehicle, for example a vehicle speed. The information about the dynamics of the vehicle can be read from an inertial measurement system or navigation sensor fitted on the vehicle, such that the information can contain data about the longitudinal dynamic and transverse dynamic of the vehicle, for example a position or a rotation of the vehicle.

The dynamics of the vehicle in the superordinate coordinate system can include a longitudinal dynamic of the vehicle in the superordinate coordinate system. Alternatively, or in addition, the dynamics of the vehicle in the superordinate coordinate system can include a transverse dynamic of the vehicle in the superordinate coordinate system. The longitudinal dynamic of the vehicle can include or define a speed of the vehicle and the transverse dynamic or can define a steering angle of the vehicle.

The control of the operational safety system of the vehicle can comprise a control of the future longitudinal dynamic. Alternatively, or in addition, the control of the operating system can comprise a control of the future transverse dynamic of the vehicle. With the method, therefore, as a function of a recognized ground-level obstacle the dynamic of the vehicle can be accessed and driving over the ground-level obstacle, which could pose a safety risk for the vehicle, can be avoided.

According to a further embodiment of the method, the environment detection sensor system can comprise radar equipment. The radar equipment can be a Doppler radar unit. With the radar equipment the measurement data about the surface of the substrate ahead of the vehicle in its travel direction can be determined. From the measurement data from the radar unit, on the basis of the Doppler effect movement vectors on the surface of the substrate can be determined. Thus, the movement vectors of the recognized ground-level obstacle can be determined in a vehicle-associated coordinate system, which can correspond to a sensor coordinate system of the radar unit on the basis of measurement data captured at a determination time. The radar unit can be one that measures over an area or over a flat area. In other words, the radar unit can be one that measures in two dimensions, or a three-dimensionally measuring radar unit.

In a further embodiment of the method, the environment detection sensor system can comprise an ultrasonic sensor. With the ultrasonic sensor, measurement data about the surface of the substrate lying ahead of the vehicle in its travel direction can be determined. The ultrasonic sensor can be an ultrasonic sensor measuring in a fan-like or planar manner. In other words, the ultrasonic sensor can be one that measures in two dimensions, or a three-dimensionally measuring ultrasonic sensor.

According to this embodiment, the step of determining the movement vector of the ground-level obstacle recognized in the vehicle-associated coordinate system can be carried out on the basis of the measurement data of the radar unit read in. A movement of the radar unit itself, which can result from a movement of the vehicle in the superordinate coordinate system, can be taken into account in the further step of determining the movement vector of the vehicle in the superordinate coordinate system. If the environment detection sensor system comprises the radar unit, the movement vector of the ground-level obstacle can also be determined continuously while the vehicle is driving.

In an embodiment of the method, in a further step a movement vector of the ground-level obstacle can be determined in the superordinate coordinate system on the basis of the two movement vectors determined. The movement vector of the ground-level obstacle in the superordinate coordinate system can be a movement vector independent of the movement of the vehicle, which can establish a dynamic or movement of the ground-level obstacle relative to the static areas of the substrate. Thus, on the basis of the two movement vectors determined, a conclusion can be drawn about a dynamic or movement of the ground-level obstacle.

According to a further embodiment of the method, as a further step the method can comprise a transformation of the movement vector of the recognized ground-level obstacle, determined from the vehicle-associated coordinate system to the coordinate system which is superordinate relative to the vehicle-associated coordinate system. The transformation can be based on the movement vector of the vehicle determined in the superordinate coordinate system. The transformation can comprise an addition of the movement vector of the vehicle determined in the superordinate coordinate system to the movement vector of the ground-level obstacle determined. The transformation can be based on a known installation position or a known extrinsic calibration of the environment detection sensor system on the vehicle. Furthermore, the transformation can include at least one of a translation and a rotation of the movement vector determined.

Thus, the movement vector of the vehicle can function as a correction parameter for determining the movement vector of the recognized ground-level obstacle in the vehicle-associated coordinate system. Moreover, the transformation can also be based on a current position of the vehicle-associated coordinate system in the superordinate coordinate system.

In this embodiment, the step of checking can be carried out on the basis of a comparison of the movement vectors of the vehicle and the ground-level obstacle in the superordinate coordinate system. The comparison of the movement vectors can comprise a comparison of their sizes in the superordinate coordinate system. Alternatively, or in addition, the comparison of the movement vectors can comprise a comparison of the orientations of the movement vectors.

In a further embodiment of the method, the movement vectors can be three-dimensional movement vectors. Moreover, at least one of the coordinate systems can be a three-dimensional coordinate system. The step of transforming the movement vector of the ground-level obstacle determined can therefore consist of a three-dimensional transformation of the movement vector of the ground-level obstacle determined. Accordingly, a dynamic of the ground-level obstacle can be determined three-dimensionally or spatially.

In a further embodiment of the method, the operational safety system can include a warning device for warning a driver of the vehicle before the vehicle is driven over the ground-level obstacle. The warning device can be an acoustic warning device for emitting an acoustic warning signal. Alternatively, or in addition, the warning device can be a visual warning device for emitting a visual warning signal. In this embodiment, in the step of emitting the control signal a control signal for actuating the warning device is emitted. On the basis of the control signal the warning device can be activated. Thus, the vehicle driver can be warned efficiently before driving over the ground-level obstacle, which can pose a safety risk for driving with the vehicle.

According to a further embodiment of the method, the operational safety system can comprise a communication device for communicating the ground-level obstacle to other vehicles or traffic participants. Thus, other vehicles or traffic participants near the vehicle can also be warned about the ground-level obstacle.

In a further embodiment of the method, the operational safety system can comprise an operating device for intervening in the operation of the vehicle. The operating device can comprise a brake device for braking the vehicle. The brake device can comprise a service brake of the vehicle. The operating device can comprise a chassis device of the vehicle. The chassis device can comprise a suspension of the vehicle. The operating device can comprise a transmission device. The transmission device can comprise a differential lock. In this embodiment, in the step of emitting the control signal a control signal for controlling the brake device can be emitted. The brake device can be actuated for the automated braking of the vehicle. The automated braking can bring about an automated slowing-down of the vehicle. In addition, the automated braking can bring about an automated stopping of the vehicle. In that way, driving over the ground-level obstacle can be prevented. Furthermore, the brake device can be designed as an emergency braking device for carrying out an emergency braking process of the vehicle. The control signal can be emitted for controlling the chassis device. The chassis device can be designed to raise the vehicle body relative to the ground. The control signal can be emitted for controlling the transmission device. The transmission device can be actuated to change the gear ratio. Thus, in an efficient manner a reaction by the vehicle can be triggered in the event that driving over the ground-level obstacle cannot be prevented, or is even based on the driver's wish. In a further embodiment of the method, the operational safety system can comprise a steering device for steering the vehicle. In this embodiment, in the step of emitting the control signal a control signal for controlling the steering device can be emitted. On the basis of the control signal, the steering device can be actuated in such manner that the ground-level obstacle ahead of the vehicle in its travel direction is bypassed by the vehicle.

In a further aspect, the present invention relates to a control unit for controlling a vehicle. The control unit can be designed to carry out the method in accordance with the preceding aspect. The control unit can comprise corresponding interfaces or units for carrying out the steps of the method in accordance with the preceding aspect. The control unit can be designed as part of a driver-assistance system, such that the control unit can control at least one driver-assistance system.

The control unit has an interface for reading measurement data about a surface of a substrate ahead of the vehicle in its travel direction, such that on the substrate there is a ground-level obstacle. For the purpose of reading in the measurement data, the control unit can be connected with the environment detection sensor system by way of the interface. The control unit comprises a recognition unit for recognizing, from the measurement data read in, the ground-level obstacle on the ground ahead.

The control unit comprises a determination unit for determining a movement vector of the ground-level obstacle recognized in the vehicle-associated coordinate system and a movement vector of the vehicle in the coordinate system superordinate relative to the vehicle coordinate system. The control unit comprises a checking unit for checking whether the ground-level obstacle recognized is a dynamic ground-level obstacle in the superordinate coordinate system, wherein the check is based on a comparison of determined movement vectors.

The control device also comprises an interface for emitting a control signal for controlling an operational safety system of the vehicle as a function of a check result from the checking process. The control unit can be connected to the operational safety system by way of the interface for emitting the control signal. The operational safety system can function as the driver-assistance system or it can be part thereof.

In a further aspect, the present invention relates to a vehicle which comprises an operational safety system. The operational safety system can be designed as described for the preceding aspects. The vehicle also comprises a control unit in accordance with the preceding aspect for controlling the operational safety system. The vehicle can be in the form of an at least partially automatically operated vehicle. In an embodiment of the vehicle, the vehicle is a self-driving working machine. The self-driving working machine can be in the form of an at least partially automatically operating self-driving working machine. The self-driving working machine can be in the form of an autonomously self-driving working machine.

Embodiments and features that are described in relation to one aspect of the present invention can also form corresponding embodiments or features of the other aspects.

### BRIEF DESCRIPTION OF THE FIGURES

The figures show:

FIG. 1: A vehicle with a control unit for controlling the vehicle, according to a particular embodiment of the invention.

FIG. 2: The control unit for controlling an operational safety system of the vehicle, according to an embodiment of the invention.

FIG. 3: A flow chart with process steps for carrying out a method for controlling a vehicle, according to an embodiment of the invention.

### DETAILED DESCRIPTION OF EMBODIMENTS

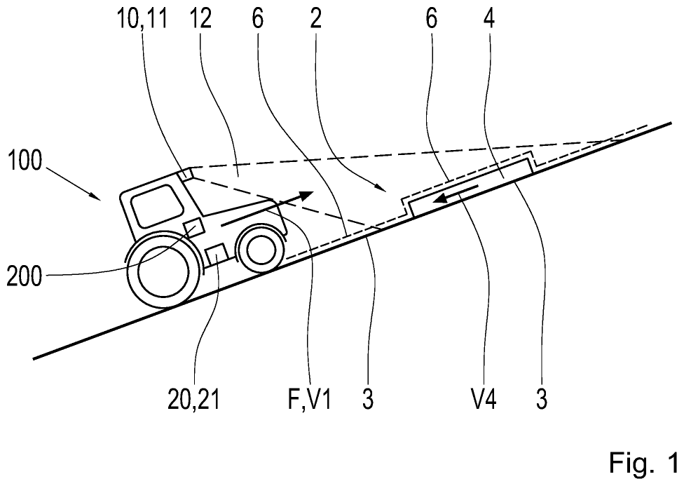

FIG. 1 shows a vehicle 100. In the embodiment shown the vehicle 100 is in the form of a self-driving working machine, for example a tractor. The vehicle 100 is moving in the travel direction F of the vehicle 100. The vehicle 100 is moving over a substrate 2. The substrate 2 has a surface 6 over which the vehicle 100 can drive.

The substrate 2 has a ground-level obstacle 4, which is on a ground 3 of the substrate 2. The ground-level obstacle 4 is moving relative to the ground 3 of the substrate 2. The surface 6 of the substrate 2 forms a common surface 6 of the ground 3 and the ground-level obstacle 4. Owing to the movement of the ground-level obstacle 4, the surface 6 of the substrate 2 changes.

The vehicle 100 comprises an environment detection sensor system 10. In an embodiment the environment detection sensor system 10 is fixed to a vehicle body or to a vehicle frame of the vehicle 100. The environment detection sensor system 10 covers a detection field 12, which is directed obliquely downward onto the surface 6 of the substrate. The surface 6 detected in the detection field 12 has a surface zone formed by the ground-level obstacle 4. In an embodiment, the environment detection sensor system 10 comprises a radar unit 11, which scans the surface 6 in the detection field 12 on a radar basis. If the radar unit 11 is a Doppler radar unit, then from the measurement data of the radar unit 11 a movement vector V4 of the ground-level obstacle 4 is determined in a vehicle-associated coordinate system (not shown in the figures). In an embodiment the vehicle-associated coordinate system is a sensor coordinate system of the radar unit 11.

The vehicle 100 also comprises a sensor system 20 for determining a dynamic of the vehicle 100 in a coordinate system (not shown in the figures) which is superordinate relatively to the vehicle-associated coordinate system. The sensor system 20 comprises a navigation sensor 21 for determining a movement vector V1 of the vehicle 100. According to an embodiment the navigation sensor 21 is part of an inertial measurement system.

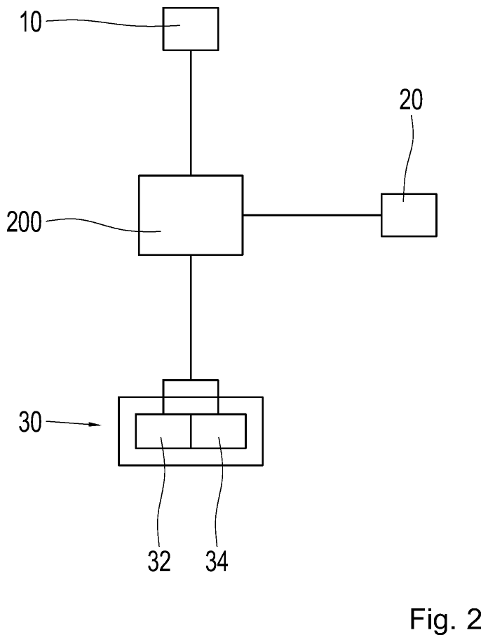

The vehicle 100 comprises a control unit 200 for controlling the vehicle 100, as explained in greater detail in FIG. 2. The control unit 200 is connected to an operational safety system 30 of the vehicle 100, shown in FIG. 2. The control unit 200 is also connected to the environment detection sensor system 10 and to the sensor system 20 of the vehicle 100. In an embodiment, the operational safety system 30 of the vehicle 100 comprises a warning device 32 for warning an operator or driver of the vehicle 100 about the ground-level obstacle 4 ahead in the travel direction F of the vehicle 100. In a further embodiment, the operational safety system 30 of the vehicle 100 comprises an operating device 34, which is designed to intervene in the operation of the vehicle 100 in order to prevent a collision of the vehicle 100 with the ground-level obstacle 4. According to an example embodiment, the operating device 34 is designed to brake the vehicle 100.

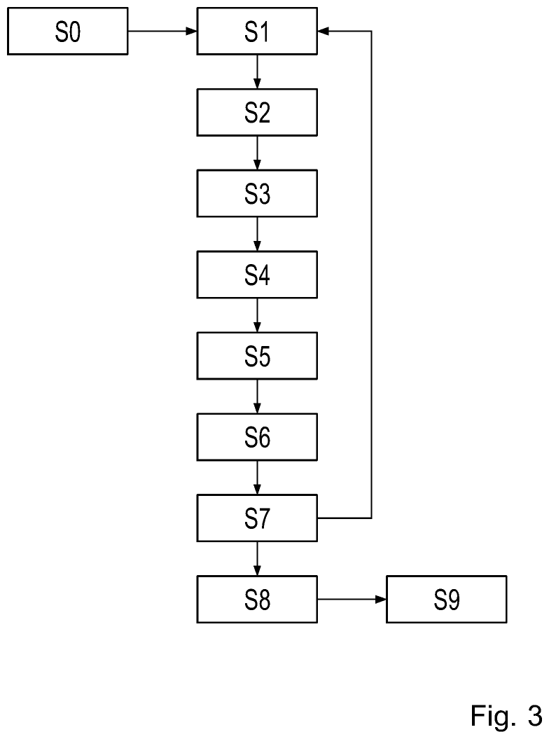

FIG. 3 shows process steps for carrying out a method for controlling the vehicle 100 in accordance with an embodiment, in a time sequence of the said process steps. The steps S0 to S7 are carried out by the control unit 200 shown in FIG. 2. The control unit 200 can actuate the warning device 32 for warning the operator or driver of the vehicle 100, or it can actuate the operating device 34.

In an optional step S0, measurement data are collected about the surface 6 of the substrate 2 ahead of the vehicle 100 in its travel direction F. The measurement data are captured within the detection field 12 of the environment detection sensor system 10, wherein a ground-level nearby area of the surface 6 of the substrate 2 is scanned in the travel direction F ahead of the vehicle 100. In an embodiment not shown in the figures, the detection field 12 is filtered in a ground-level strip, as a function of a spatial orientation of the vehicle 100 in the superordinate coordinate system. In a step S1 of the method, the captured measurement data about the surface 6 of the substrate 2 ahead of the vehicle 100 in its travel direction F are read in. The read-in measurement data include measurement data about the surface zone of the surface 6 formed by the ground-level obstacle 4.

In a further step S2 of the method, a recognition of the ground-level obstacle 4 is carried out from the read-in measurement data. In an embodiment, the recognition is carried out in the ground-level strip (not shown in the figures). The recognition of the ground-level obstacle 4 in the read-in measurement data is carried out on the basis of the measurement data captured by the radar unit 11. In the recognition step S2, a ground-level obstacle 4 moving in the vehicle-associated coordinate system is recognized. An outline of the ground-level obstacle 4 moving in the vehicle-associated coordinate system is recognized on the basis of movement information about the ground-level obstacle 4, which information is derived directly from the measurement data of the radar unit 11. In a further step S3 a determination of the movement vector V4 of the recognized ground-level obstacle 4 in the vehicle-associated coordinate system is carried out on the basis of read-in measurement data. The movement vector V4 of the recognized ground-level obstacle 4 is determined from the movement information in the measurement data of the radar unit 11.

In a further, optional step not shown in FIG. 3, information about the dynamic of the vehicle 100 in the superordinate coordinate system is determined by the navigation sensor 21. In a further step S4 the said information is read in. In yet another further step S5 the movement vector V1 of the vehicle 100 is determined in the superordinate coordinate system on the basis of the read-in information about the dynamic of the vehicle 100. The movement vector V1 of the vehicle 100 is determined from the measurement data of the navigation sensor 21.

In a further step S6 the movement vectors V1, V4 of the vehicle 100 and the ground-level obstacle 4 are compared. If the movement vectors V1, V4 do not fulfill predetermined epipolar conditions or if the movement vectors V1, V4 do not cancel each other out in a vector addition, it is established that the ground-level obstacle 4 is moving relative to the ground 3 of the substrate 2. In a further step S7 it is checked whether this is a ground-level obstacle 4 moving in that manner. In an embodiment the steps S1 to S7 are carried out in a loop or repeatedly, until the check result found in step S7 reaches a predetermined number.

If the check result in the checking step S7 is found at least once, then in a further step S8 a control signal for controlling the operational safety system 30 is emitted. In a further step S9 the operational safety system 30 is controlled on the basis of the control signal emitted. The control can include the activation of at least one of the warning device 32 and the operating device 34.

### INDEXES

2 Substrate
3 Ground
4 Ground-level obstacle
6 Surface
10 Environment detection sensor system
11 Radar unit
12 Detection field
20 Sensor system
21 Navigation sensor
30 Operational safety system
32 Warning device
34 Operating device
100 Vehicle
200 Control unit
F Travel direction
S0 Capture of measurement data
S1 Reading-in of measurement data
S2 Recognition of obstacle
S3 Determination of the movement vector of the obstacle
S4 Reading-in of information
S5 Determination of the movement vector of the vehicle
S6 Comparison of the movement vectors
S7 Checking of the dynamic obstacle
S8 Emitting a control signal
S9 Control of the operational safety system
V1 Movement vector of the vehicle
V4 Movement vector of the obstacle

1-10. (canceled)

11. A method for controlling a vehicle (100) having an operational control system, the method comprising:
reading-in (S1), by an environment detection sensor system of a vehicle, measurement data about a surface (6) of a substrate (2) ahead of the vehicle (100) in a travel direction (F) of the vehicle, wherein the surface contains a ground-level obstacle (4);
recognizing (S2) the ground-level obstacle (4) in the measurement data;
determining (S3), by a vehicle-associated coordinate system, a first movement vector (V4) of the ground-level obstacle (4) on the basis of the measurement data;
determining (S5) a second movement vector (V1) of the vehicle (100) in a coordinate system that is superordinate relative to the vehicle-associated coordinate system;
checking (S7) whether the ground-level obstacle (4) is a dynamic ground-level obstacle (4) in the superordinate coordinate system, wherein the checking (S7) is carried out on the basis of a comparison (S6) with the first movement vector (V4) and the second movement vector (V1); and
emitting (S8) a control signal for controlling (S9) the operational safety system (30) of the vehicle (100) as a function of the comparison (S6) of the first movement vector (V4) and the second movement vector (V1).

12. The method according to claim 11, further comprising reading-in (S4) information about a dynamic of the vehicle (100) in the superordinate coordinate system, wherein the information is based on measurement data determined by a sensor system (20) installed on the vehicle (100), and wherein the step (S5) of determining the movement vector (V1) of the vehicle (100) is based on the information read in.

13. The method according to claim 11, wherein the environment detection sensor system (10) comprises a radar unit (11) configured to capture the measurement data about the surface (6) of the substrate (2) ahead of the vehicle (100) in its travel direction (F), wherein the step (S3) of determining the first movement vector (V4) of the recognized ground-level obstacle (4) is carried out in the vehicle-associated coordinate system on the basis of the measurement data captured by the radar unit (11).

14. The method according to claim 11, further comprising transforming the first movement vector (V4) determined for the ground-level obstacle (4) from the vehicle-associated coordinate system to the coordinate system superordinate relative to the vehicle-associated coordinate system, wherein the checking step (S7) is carried out on the basis of a comparison (S6) of the first and second movement vectors (V1, V4).

15. The method according to claim 11, wherein the first and second movement vectors (V1, V4) are three-dimensional movement vectors (V1, V4).

16. The method according to claim 11, wherein the operational safety system (30) comprises a warning device (32) configured for warning a vehicle driver before the vehicle is driven over the ground-level obstacle (4), and wherein emitting (S8) the control signal includes emitting a control signal for actuating the warning device (32).

17. The method according claim 16, wherein the operational safety system (30) comprises an operating device (34) configured for intervening in the operation of the vehicle (100), and wherein emitting (S8) the control signal includes emitting a control signal for actuating the operating device (34).

18. A control unit (200) for controlling a vehicle (100), comprising:
an interface configured to read-in measurement data about a surface (6) of a substrate (2) lying ahead of the vehicle (100) in its travel direction (F), which surface contains a ground-level obstacle (4);
an environment detection sensor system (10) installed on the vehicle (100), the environment detection sensor system (10) configured to capture the measurement data;
a recognition unit configured to recognize the ground-level obstacle (4) from the measurement data read in;
a determination unit configured to determine a first movement vector (V4) of the ground-level obstacle (4) in a vehicle-associated coordinate system and a second movement vector (V1) of the vehicle (100) in a coordinate system superordinate relative to the vehicle coordinate system;
a checking unit configured to check whether the ground-level obstacle (4) is a dynamic ground-level obstacle (4) in the superordinate coordinate system, wherein the checking is carried out on the basis of a comparison of the first and second movement vectors (V1, V4); and
an interface configured to emit a control signal for controlling an operational safety system (30) of the vehicle (100) as a function of the result of checking whether the ground-level obstacle (4) is a dynamic ground-level obstacle.

19. A vehicle (100) comprising;
an operational safety system (30); and
a control unit (200) according to claim 18 for controlling the operational safety system (30).

20. The vehicle (100) according to claim 19, wherein the vehicle (100) is a self-driving working machine.
